(19) United States
(12) Patent Application Publication
(10) Pub. No.: US 2024/0319102 A2
(43) Pub. Date: Sep. 26, 2024

(54) A SYSTEM AND METHOD FOR THE AUTOMATIC AND CONTINUOUS HIGH-SPEED MEASUREMENT OF COLOR AND GEOMETRY CHARACTERISTICS OF PARTICLES

(71) Applicant: SHELL OIL COMPANY, HOUSTON, TX (US)

(72) Inventors: Majeed SHAIK, Bangalore (IN); Lorna ORTIZ-SOTO, Houston, TX (US); Jose GONZALEZ MARTINEZ, Amsterdam (NL); Cornelis DE GRAAF, Amsterdam (NL); Constant GUEDON, Amsterdam (NL)

(21) Appl. No.: 18/007,059

(22) PCT Filed: Sep. 23, 2021
(86) PCT No.: PCT/US2021/051645

§ 371 Date: Jan. 27, 2023

Related U.S. Application Data
(60) Provisional application No. 63/057,718, filed on Jul. 28, 2020.

(51) Int. Cl. G01N 21/84; G01B 11/24; G01N 21/25

(52) U.S. Cl. CPC G01N 21/84; G01B 11/24; G01N 21/251; G01N 2021/845

(57) ABSTRACT

A system and method for the automatic and continuous high-speed measurement of color and geometry characteristics of solid shaped particles. The system includes a shaped particle feeder that sorts and aligns singularized particles and feeds them onto a means for moving the singularized shaped particles to a color inspection station and a shape inspection station. The color inspection station provides for measuring the color of each singularized shaped particle and the shape inspection station provides for measuring the geometry characteristics of each singularized shaped particle. This information is analyzed by a master computer with the statistical information displayed.

This invention relates a system and method for the automatic and continuous high-speed measurement of color and geometry characteristics of solid particles.

### BACKGROUND OF THE INVENTION

Industry uses catalyst compositions to promote chemical reactions to produce a wide variety of commercial products. Among these compositions are heterogeneous catalysts that are typically in solid form and used to catalyze reactions of molecules in the gas and liquid phases. Manufacturers make these catalysts into particles having all types of shapes, sizes, and colors. The color of catalyst particles can be an indication of its composition. In their manufacture a uniform color of catalyst particles suggests that they have a consistent compositional quality. The catalyst particles may be prepared as cylinders, spheres and multi-lobed shapes, such as, dual-lobes, trilobes, and quadralobes. The dimensions of these shapes can fall within a wide range. The lengths of the particles may be within the range of from 0.4 mm up to 20 mm and widths or diameters may be within the range of from 0.4 mm to 15 mm.

In many chemical processes heterogeneous catalyst particles are loaded into reactor vessels as fixed beds. In these reactors it is important for the catalyst particles to have a consistent quality; because, the shape and size of the particles and the way they are loaded can affect the performance of the reaction. Extreme variation in the shapes can affect the packing of the particles in the catalyst bed of the reactor vessel. Broken catalyst particles will pack within the catalyst bed and cause excessive pressure drop. Thus, controlling the quality of the catalyst particles is important to maintaining good operation of the reactor.

Catalyst manufacturers typically assess the quality of manufactured particles by manual and visual methods. But, it would be desirable to have a rapid means for automatically and continuously assessing the color and geometry characteristics of large sample batches of the catalyst particles.

The prior art discloses a number of systems and methods for automatically measuring the geometric properties of samples batches of particles. Several of these methods are applied to measuring the properties of agricultural grains. For instance, U.S. Pat. No. 7,830,530 discloses an optical device and method for measuring 3D surface properties of individual agricultural grains such as grains of wheat, corn, barley, rice and beans. The device includes a feeder conveyor belt that moves the grain sample to a location for optical measurement. A light source illuminates the individual grains and reflection of the light is detected by a detector such as a digital camera for acquiring an image of the grains. An analyzer that is adapted to process the detected reflection is used to determine a height profile for the grain and 3D surface information (topographical information) to assess the quality of the grains.

Another automatic measuring method is disclosed in U.S. Pat. No. 9,091,643. This patent presents a device for quantitatively analyzing components of agricultural grain kernels by irradiating them and optically detecting the spectrum of light transmitted through or reflected from the grain kernels. The device includes a light source that emits light onto the kernels. A spectrum detector, such as a digital camera, detects the spectrum of light transmitted through or reflected from the kernels. This spectrum detector provides digital information relating to the captured light spectrum to a computing unit, such as a computer. The computing unit executes a program implementing a predetermine algorithm using a calibration curve that correlates the spectrum values and the content of the specific components of the kernels.

U.S. Patent Application U.S. 2014/0036069 discloses the use of a camera system for the detection of the flow of objects moving relative to the cameras on a conveyor belt. Multiple cameras are used as code readers and geometry detection sensors. A control and evaluation unit, such as a computer, processes the image information and code data received from the cameras and presents output information.

### BRIEF SUMMARY OF THE INVENTION

It is an object of the invention to provide for the automatic and continuous high-speed measurement of color and geometry characteristics of shaped particles.

Accordingly, provided is a vision inspection system for the automatic and continuous high-speed measurement of color and geometry characteristics of catalyst pellets. The vision inspection system comprises bowl feeder means for sorting and aligning catalyst pellets and presenting singularized pellets onto transporting means for moving the singularized pellets to a color inspection station and to a shape inspection station. Bowl inspection means provides for monitoring the catalyst pellets contained in the bowl feeder means and generating a bowl inspection signal containing pellet quantity information representative of a number or presence of catalyst pellets contained in the bowl feeder means. The color inspection station includes color measurement means for receiving reflected light from each of the singularized pellets and generating a color signal containing color information representative of the color of each singularized particle. The shape inspection station includes geometry measurement means for sensing width, length and curvature characteristics of each singularized pellet and generating a geometry signal containing geometric information representative of the geometric characteristics of each singularized particle.

Further provided is a process for the automatic and continuous high-speed measurement of color and geometry characteristics of catalyst pellets. The process comprises sorting and aligning catalyst pellets within a pellet feeder. The catalyst pellets contained in the pellet feeder are monitored and a bowl inspection signal containing pellet quantity information representative of a number or presence of the catalyst pellets contained in the pellet feeder is generated. The singularized pellets are transferred at a moving speed from the pellet feeder to a color inspection station and to a shape inspection station. The color inspection station measures reflected light from each singularized pellet and generates a color signal containing information representative of the color of the singularized pellet. The shape inspection station measures the width, length and curvature characteristics of each singularized pellet and generates a geometry signal containing geometric information representative of the geometric characteristics of the singularized pellet.

### BRIEF DESCRIPTION OF THE FIGURES

This specification provides the following figure to help describe and illustrate the invention.

The Figure is a schematic illustrating an embodiment of the inventive inspection tool system for the automatic and continuous high-speed measurement of color and geometry characteristics of shaped particles such as catalyst pellets.

### DETAILED DESCRIPTION OF THE INVENTION

The inventive process provides for automatic and continuous high-speed measurement of color and geometry characteristics of shaped particles. This process is particularly useful for measuring color and geometry characteristics of catalyst pellets. In the manufacture of heterogeneous catalysts an important aspect of quality control is for the catalyst particles to have consistent color, shape and size. To assess the quality of a batch of catalyst particles, an individual typically obtains a representative sample of the larger batch and visually examines the individual catalyst particles for color, shape and size.

The inventive process applies an automatic feeding and optical system configured to provide for high-speed measurement of color, shape and size properties of an inventory of catalyst pellets without the need for a person to visually perform the examination and assessment of the catalyst pellets. The inventive process performs the measurements and assessment of the properties of the catalyst pellets by passing singularized catalyst pellets from a batch of catalyst pellets past or through a color inspection station and a shape inspection station. The color inspection station measures the color of each singularized catalyst pellet preferably by means of a digital color camera. The shape inspection station measures the geometric characteristics of each singularized catalyst pellet preferably by use of at least two monochromatic digital cameras.

The process is capable of measuring the color and shape properties at a rate of upwardly to 750 catalyst pellets per minute, and, typically, at a rate in the range of from 400 to 700 catalyst pellets per minute. It is preferred to process at least 450 catalyst pellets per minute and present the results of the color and shape measurements of a sample batch of a single run of upwardly to 100,000 catalyst pellets.

The process includes sorting and aligning catalyst pellets of an inventory of catalyst pellets contained within a pellet feeder. The pellet feeder introduces singularized pellets onto a conveyor that transfers them from the pellet feeder at a moving speed or rate to the color inspection station and the shape inspection station.

The color inspection station is configured to measure and provide for measuring reflected light from each of the singularized pellets and generating a color signal containing information representative of the color of each of the singularized pellets. The shape inspection station is configured to measure and provide for measuring the width, length and curvature characteristics of each of the singularized pellets and generating a geometry signal containing geometric information representative of the geometric characteristics of each of the singularized pellets.

To control the pellet feeder, a bowl feeder inspection device, such as a digital camera, provides for monitoring the number or presence, or both, of catalyst pellets contained in the pellet feeder. This feeder inspection device generates and provides for generating a bowl inspection signal containing pellet quantity information representative of the number or presence of catalyst pellets contained in the pellet feeder.

To operate the pellet feeder, it is equipped and provided with a pellet feeder driver operatively connected to control its operating parameters of vibration frequency and vibration amplitude. To provide for transferring and movement of the singularized pellets from the pellet feeder to the color and shape inspection stations, a conveyor is equipped and provided with a conveyor driver operatively connected to control the moving speed of the conveyor and, thus, the singularized pellets.

The color and shape inspection stations provide information to a master computer that analyzes the color information received from the color inspection station and the geometric information received from the shape inspection station. A color signal is generated and transmitted by the color inspection station and contains color information representative of the color of each singularized particle. A geometry signal is generated and transmitted by shape inspection station and contains geometric information representative of the geometric characteristics of each singularized particle.

The color and geometry signals are processed to provide first processed information and second processed information that both are transmitted to the master computer that further processes this information by the application of statistical algorithms and which displays the resulting statistical information and analysis relating to the pellet characterizations.

A programmable logic controller is used to receive and process input information regarding the operation of the pellet feeding system and the pellet conveying system. Based upon the application of the programmed logic rule, the programmable logic controller transmits output control signals to the pellet feeding and conveying systems to control their operation as more fully described with respect to the Figure.

The Figure presents a schematic depiction of an embodiment of inventive vision inspection system 10 that also enables application of the inventive process. Vision inspection system 10 provides for the automatic and continuous measurement of color and geometry characteristics of shaped particles. The shaped particles can have a variety of shapes, sizes, and colors. In particular, vision inspection system 10 can be used to automatically and continuously measure the geometry and color characteristics of catalyst pellets.

Vision inspection system 10 provides for measuring the characteristics of the individual pellets of a sample batch of catalyst pellets taken as a representative sample from a larger volume of catalyst pellets in order to estimate the properties of the larger volume of catalyst pellets based on those of the representative sample batch. The shapes of the catalyst pellets may be cylinders, spheres and multi-lobed pellets, such as, dual-lobes, trilobes, quadralobes, and other polylobal shapes. The dimensions of these shapes can fall within a wide range of sizes. The lengths of the particles may be within the range of from 0.4 mm up to 20 mm, and their widths or diameters may be within the range of from 0.4 mm to 15 mm.

Vision inspection system 10 includes bowl feeder means 12 that provides for sorting and aligning catalyst pellets and for introducing singularized pellets onto transporting means 14. Bowl feeder means, or bowl or pellet feeder 12 can be any feeder system or pellet feeder that is capable of feeding singularized catalyst pellets onto transporting means 14. It is preferred for bowl feeder means 12, or bowl feeder, to be selected from any known vibratory feeder system such as any of the commercially available vibratory bowl feeders. Examples of suitable bowl feeders are available from manufacturers such as Grimm Feeding Systems Ltd., RNA Automation Ltd., Hoosier Feeder Company and others.

Bowl feeder 12 typically comprises a bowl top 16 that is a circularly-shaped open container or bowl-shaped container. Bowl top 16 may be selected from any one of several suitable circular designs that include cylindrical bowls, conical bowls, and stepped bowls. Bowl top 16 defines an inside surface or wall 18 and a bottom surface 20 that in combination define open volume 22 for receiving shaped particles.

The bowl feeder inside wall 18 has or defines helically inclined track or ramp 26 extending from the bottom surface 20 and bottom end 28 of bowl top 16 to top end 30 of bowl top 16. Helically inclined track 26 has length, width, and slope designed for the specific application of providing for conveying catalyst pellets contained within open volume 22 of bowl feeder 12 upwardly along helically inclined track 26 when bowl feeder 12 is vibrated.

Bowl top 16 is operatively connected to or mounted on operating means 32. Operating means 32 provides for controlling the operating parameters of bowl feeder 12. Operating means 32 can include a vibrating drive unit capable of vibrating bowl top 16 at the desired operating parameters. The operating parameters include the vibration frequency and vibration amplitude of bowl top 16. Vibration of bowl top 16 causes the catalyst pellets contained in open volume 22 to move upwardly along helically inclined track 26 of bowl top 16 to top end 30 for discharge onto transportation means 14.

Bowl top 16 can be made of a wide range of materials, including stainless steel, aluminum, polymers or any other suitable material. The size of bowl feeder 12 may include any suitable dimensions that provides for the desired testing capacity of vision inspection system 10.

Typically, the diameter of the bowl top 16 of bowl feeder 12 can be in the range of from 10 mm to 1,500 mm, and, more typically, from 50 mm to 1,200 mm. Most typically, for a laboratory scale vision inspection system 10 the dimensions of bowl top 16 of bowl feeder 12 depends on the geometry of bowl top 16. For cylindrical bowl tops, the diameter is in the range of from 150 mm to 800 mm. For conical bowl tops, the top end diameter is in the range of from 300 mm to 950 mm and the bottom end diameter is in the range of from 200 to 660 mm. For step-shaped bowl tops, the top end diameter is in the range of from 200 mm to 900 mm and the bottom end diameter is in the range of from 150 to 650 mm.

Transporting means 14 is any suitable means for moving the singularized pellets received from bowl feeder means 12 to color inspection station 34 and shape inspection station 36. Transportation means 14 may include means, such as conveyor belt 38, that are associated with two or more pulleys 40 and driving means 42. Driving means 42 is operatively connected to or associated with transportation means 14 and conveyor belt 38. Driving means 42 provides for controlling the moving speed at which the singularized pellets are transported to color inspection station 34 and shape inspection station 36. Driving means 42 may include an electric motor connected to pulley 40 for driving conveyor belt 38 in the directions shown by arrows 44 and 46. Driving means 42 may suitably include a servo motor with an integrated encoder.

Conveyor belt 38 can be made of any suitable material that provides for the transport and movement of the singularized pellets. The belting material may be selected from a variety of materials including fabrics, rubbers, polymers, and metals. It can be desirable for the belting material to have a rough surface that provides friction with the deposited catalyst pellets that keeps them in place on conveyor belt 38 during the movement of conveyor belt 38. The belting material can also have channels or depressions on its surface that assist in maintaining the catalyst pellets positioned on conveyor belt 38.

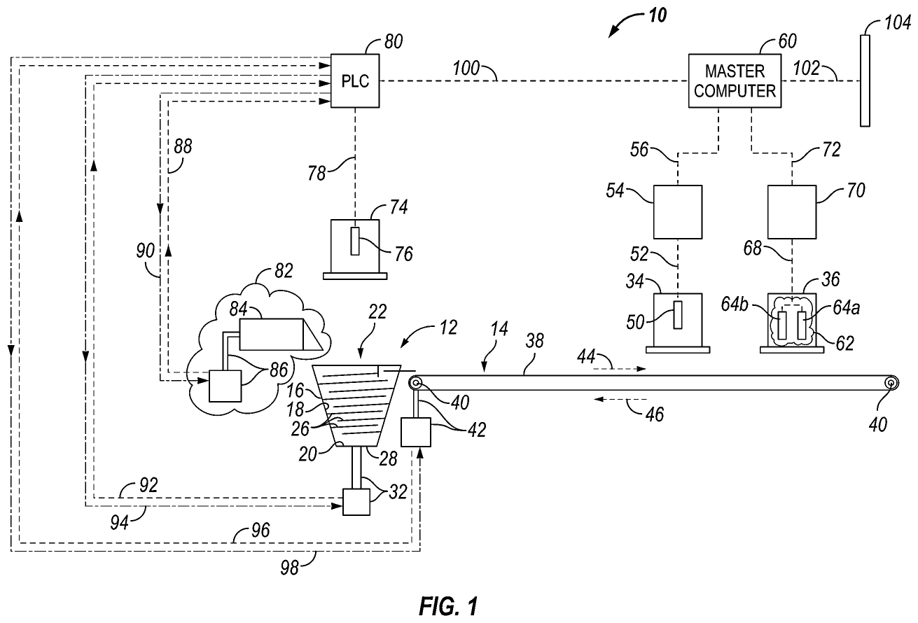

The singularized catalyst pellets placed on conveyor belt 38 are transferred at a moving speed from bowl feeder 12 in the direction indicated by arrow 44 to color inspection station 34 and shape inspection station 36. While FIG. 1 shows the two inspection stations in a particular order, it is understood that they may be arranged in any order relative to the movement of the catalyst pellets, since the order at which the information is collected is not critical to the operation of vision inspection system 10.

Color inspection station 34 provides for measurement and determination of the color of each singularized catalyst pellet that passes past color inspection station 34. Color inspection station 34 includes color measurement means 50. Color measurement means 50 can be a color digital camera or any other device capable of receiving reflected light from each of the singularized catalyst pellets that passes color inspection station 34 and capable of generating a color signal 52 that contains information representative of the color of each of the singularized catalyst pellets.

Color measurement means 50 transmits color signal 52 to first computer means 54. First computer means 54 is capable of receiving color signal 52 and processing color signal 52 to generate first output signal 56 containing first processed information. First computer means 54 can be any suitable computing device, such as a computer, capable of processing the color information of color signal 52 and generating first output signal 56 that includes first processed information that is capable of being received by master computer means 60. First computer means 54 is loaded with software and relevant data and is programmed to process the color information of color signal 52 and to place it in a form capable of being received and interpreted by master computer means 60 to indicate the color of each singularized catalyst pellet relative to a reference.

Shape inspection station 36 provides for measurement and determination of the width, length and curvature characteristics of each singularized catalyst pellet that passes past shape inspection station 36. Shape inspection station 36 includes geometry measurement means 62. Geometry measurement means 62 is capable of visually sensing width, length and curvature characteristics of each of the singularized catalyst pellets that passes shape inspection station 36 and capable of generating one or more geometry signals containing geometric information representative of the geometric characteristic of each singularized particle that passes shape inspection station 36.

It is preferred for geometry measurement means 62 to include at least two monochromatic digital cameras 64a and 64b. Digital cameras 64a and 64b are positioned at appropriate angles with respect to conveyor belt 38 to allow for capturing the desired geometric information related to each singularized catalyst pellet.

Geometry measurement means 62 transmits geometry signal 68 to second computer means 70. Second computer means 70 is capable of receiving geometry signal 68 and processing geometry signal 68 to generate second output signal 72 containing second processed information. Second computer means 70 can be any suitable computing device, such as a computer, capable of processing the geometric information of geometry signal 68 and generating second output signal 72 that includes second processed information that is capable of being received by master computer means 60. Second computer means 70 is loaded with software and relevant data and is programmed to process the geometric information of geometry signal 68 and to place it in a form capable of being received and interpreted by master computer means 60 to indicate the geometric characteristics of each of the singularized catalyst pellets.

Bowl inspection means 74 provides for monitoring the quantity or presence of catalyst pellets contained in open volume 22 of bowl feeder means 12. Bow inspection means 74 includes a digital camera 76 or any other optical device capable of receiving information indicating the presence or non-presence of catalyst pellets residing within open volume 22. Digital camera 76 is further capable of generating bowl inspection signal 78 containing pellet quantity information representative of either the number or presence, or both, of catalyst pellets contained in open volume 22.

Digital camera 76 transmits bowl inspection signal 78 to master controller means 80. Master controller means 80 is preferably any suitable control system that is capable of receiving bowl inspection signal 78 and other information concerning the operation of various components of vision inspection system 10, and, responsive to this received information, controlling the operation of the various components of vision inspection system 10. It is preferred for master controller means 80 to be selected from among the many suitable programmable logic controllers (PLC) known in the art.

Vision inspection system 10 can include bunker feeder system 82 among its components of which the operation is controlled by master controller means 80. Bunker feeder system 82 allows for automatic feeding instead of manual feeding of bowl feeder 12 with catalyst pellets.

Bunker feeder system 82 includes dosing bunker means 84 that provides for holding an inventory of catalyst pellets and feeding catalyst pellets into open volume 22 of bowl feeder means 12. Dosing bunker means 84 is preferably a vibratory feeder that provides for introducing catalyst pellets into open volume 22. Vibratory feeders are known in the art. A wide variety of vibratory feeders and drive systems are commercially available from many different manufacturers and vendors.

Bunker operating means 86 is operatively connected to dosing bunker means 84. Bunker operating means 86 provides for controlling the bunker operating parameters of bunker dosing means 84. The bunker operating parameters include vibration frequency and vibration amplitude of bunker dosing means 84.

Associated or integrated with bunker operating means 86 is bunker control means (not shown) for generating bunker parameters signal 88 and for receiving bunker feeder control signal 90. Bunker parameters signal 88 contains information representative of the bunker operating parameters of bunker dosing means 84. Bunker parameters signal 88 is transmitted by bunker control means to master controller means 80. Bunker feeder control signal 90 is received by bunker control means from master controller means 80. Bunker control means controls bunker operating means 86 in response to bunker feeder control signal 90.

Associated or integrated with operating means 32 is bowl feeder control means (not shown) for generating operating parameters signal 92 and for receiving bowl feeder control signal 94. Operating parameters signal 92 contains information representative of the operating parameters of bowl feeder means 12. Operating parameters signal 92 is transmitted by bowl feeder control means to master controller means 80. Bowl feeder control signal 94 is received by bowl feeder control means from master controller means 80. Bowl feeder control means controls operating means 32 in response to bowl feeder control signal 94.

Associated or integrated with driving means 42 is conveyor control means (not shown) for generating moving speed signal 96 and for receiving moving control signal 98. Moving speed signal 96 contains information representative of the moving speed of conveyor belt 38 and is transmitted by conveyor control means to master controller means 80. Mover control signal 98 is received by conveyor control means from master controller means 80. Conveyor control means controls driving means 42 in response to mover control signal 98.

Master controller means 80 is configured to control the systems providing for the feeding and movement operations of singularized catalyst pellets to color inspection station 34 and shape inspection station 36. Master controller means 80 may include a central processing unit and memory that are programmed with the appropriate logic rules that provide for processing the received input information and communicating the necessary output control signals that provide for controlling the operation of bowl feeder means 12, transporting means 14 and bunker feeder system 82.

Thus, master controller means 80 receives the following input signals:
(a) bowl inspection signal 78 transmitted by digital camera 76 that includes pellet quantity information representative of a number or presence of catalyst pellets contained in open volume 22 of bowl top 16;
(b) bunker parameters signal 88 transmitted by bunker control means that includes information representative of the bunker operating parameters of bunker operating means 86;
(c) operating parameters signal 92 transmitted by bowl feeder control means that includes information representative of the operating parameters of operating means 32; and
(d) moving speed signal 96 transmitted by conveyor control means that includes information representative of the moving speed of conveyor belt 38.

Master controller means 80 processes the information it receives from the input signals in accordance with its programming logic and transmits the following control signals to the systems for controlling the feeding and movement of singularized catalyst pellets to color inspection station 34 and shape inspection station 36:
(a) bunker feeder control signal 90 is received by bunker control means which adjusts bunker operating means 86 to thereby control the bunker operating parameters;
(b) bowl feeder control signal 94 is received by bowl feeder control means to thereby control said operating parameters of operating means 32; and
(c) mover control signal 98 is received by conveyor control means to thereby control said moving speed of conveyor belt 38.

Master controller means 80 also transmits to master computer means 60 master controller signal 100 containing information relating to control of the feeding and movement of singularized catalyst pellets. As presented above, master computer means 60 also receives first output signal 56 and second output signal 72. Master computer means 60 processes the input information it receives from master controller means 80, first computer means 54, and second computer means 70 and transmits the results of a statistical analysis of the input information by transmission of master PC output signal 102 to display monitor 104 which displays the results.

It will be apparent to one of ordinary skill in the art that many changes and modifications may be made to the described invention without departing from its spirit and scope as set forth in this specification.

That which is claimed is:

1. A vision inspection system for the automatic and continuous high-speed measurement of color and geometry characteristics of catalyst pellets, wherein said vision inspection system comprises:
bowl feeder means for sorting and aligning catalyst pellets and presenting singularized pellets onto transporting means for moving said singularized pellets to a color inspection station and to a shape inspection station;
bowl inspection means for monitoring said catalyst pellets contained in said bowl feeder means and generating a bowl inspection signal containing pellet quantity information representative of a number or presence of said catalyst pellets contained in said bowl feeder means;
wherein said color inspection station includes color measurement means for receiving reflected light from each of said singularized pellets and generating a color signal containing color information representative of the color of each said singularized particle; and
wherein said shape inspection station includes geometry measurement means for sensing width, length and curvature characteristics of each of said singularized pellets and generating a geometry signal containing geometric information representative of the geometric characteristics of each said singularized particle.

2. The vision inspection system as recited in claim 1, wherein said bowl feeder means is operatively connected to operating means for controlling operating parameters of vibration frequency and vibration amplitude of said bowl feeder means; and wherein said transporting means is operatively connected to driving means for controlling moving speed of said transporting means.

3. The vision inspection system as recited in claim 2, further comprising:
first computer means for receiving said color signal and processing said color information to provide first processed information;
second computer means for receiving said geometry signal and processing said geometric information to provide second processed information; and
master computer means for receiving and processing said first processed information and said second processed information and generating analyzed process system information relating to pellet characterizations and displaying resulting statistical information relating to pellet characterizations.

4. The vision inspection system as recited in claim 3, further comprising a bunker feeder system that includes dosing bunker means for holding an inventory of said catalyst pellets and feeding said catalyst pellets into said bowl feeder means, wherein said dosing bunker means is operatively connected to bunker feeder operating means for controlling bunker operating parameters of said dosing bunker means.

5. The vision inspection system as recited in claim 4, further comprising:
bunker control means for generating a bunker parameters signal containing information representative of said bunker operating parameters of said bunker feeder operating means and for receiving a bunker feeder control signal for controlling said bunker feeder operating means;
bowl feeder control means for generating an operating parameters signal containing information representative of said operating parameters of said bowl feeder means and for receiving a bowl feeder control signal for controlling said operating means;
conveyor control means for generating a moving speed signal containing information representative of said moving speed of said transporting means and for receiving a mover control signal for controlling said driving means; and
master controller means for receiving said bowl inspection signal, said bunker parameters signal, said operating parameters signal, and said moving speed signal, and, responsive to said bowl inspection signal, said bunker parameters signal, said operating parameters signal, and said moving speed signal, transmitting said bunker feeder control signal to said bunker feeder operating means to thereby control said bunker operating parameters, said bowl feeder control signal to said operating means to thereby control said operating parameters, and said mover control signal to said driving means to thereby control said moving speed.

6. The vision inspection system as recited in claim 5, wherein said geometry measurement means includes at least two image sensing means for capturing in digital memory said width, length and curvature characteristics and generating said geometry signal.

7. The vision inspection system as recited in claim 6, wherein said bowl feeder means further is operatively equipped with chicane means for directing and orienting single catalyst pellets onto said transporting means.

8. A process for the automatic and continuous high-speed measurement of color and geometry characteristics of catalyst pellets, wherein said process comprises:
sorting and aligning catalyst pellets within a pellet feeder;
monitoring said catalyst pellets contained in said pellet feeder and generating a bowl inspection signal containing pellet quantity information representative of a number or presence of said catalyst pellets contained in said pellet feeder;
transferring singularized pellets from said pellet feeder at a moving speed to a color inspection station and to a shape inspection station;
measuring at said color inspection station reflected light from each of said singularized pellets and generating a color signal containing information representative of the color of each said singularized pellets; and
measuring at said shape inspection station width, length and curvature characteristics of each of said singularized pellets and generating a geometry signal containing geometric information representative of the geometric characteristics of each said singularized pellets.

9. The process as recited in claim 8, further comprising:
providing a pellet feeder driver that is operatively connected to said pellet feeder to control its operating parameters of vibration frequency and vibration amplitude; and
providing a conveyor driver that is operatively connected to a conveyor for said transferring said singularized pellets at a moving speed to said color inspection station and said shape inspection station.

10. The process as recited in claim 9, further comprising:
processing said color signal to provide a first processed information;
processing said geometry signal to provide a second processed information; and
processing said first processed information and said second processed information and generating analyzed processed information and displaying resulting statistical information relating to pellet characterizations.

11. The process as recited in claim 10, further comprising:
feeding said pellet feeder from an inventory of said catalyst pellets contained in a bunker feeder

12. The process as recited in claim 11, further comprising:
generating a bunker parameters signal containing information representative of said bunker operating parameters of said bunker feeder and a bunker feeder control signal for controlling said bunker feeder;
generating an operating parameters signal containing information representative of said operating parameters of said pellet feeder and a pellet feeder control signal for controlling said operating parameters;
generating a moving speed signal containing information representative of said moving speed of said singularized pellets and a conveyor driver control signal for controlling said moving speed of said conveyor;
processing said bowl inspection signal, said bunker parameters signal, said operating parameters signal, and said moving speed signal; and
responsive to said bowl inspection signal, said bunker parameters signal, said operating parameters signal, and said moving speed signal, transmitting a bunker feeder control signal to said bunker feeder to thereby control said bunker operating parameters, said pellet feeder control signal to thereby control said operating parameters, and said conveyor driver control signal to thereby control said moving speed.

13. A vision inspection system for the automatic and continuous high-speed measurement of color and geometry characteristics of catalyst pellets, wherein said vision inspection system comprises:
a pellet feeder for sorting and aligning catalyst pellets and presenting singularized pellets onto a conveyor belt for moving said singularized pellets to a color inspection station and to a shape inspection station;
bowl inspection camera for monitoring said catalyst pellets contained in said pellet feeder and generating a bowl inspection signal containing pellet quantity information representative of a number or presence of said catalyst pellets contained in said pellet feeder;
wherein said color inspection station includes color camera for receiving reflected light from each of said singularized pellets and generating a color signal containing color information representative of the color of each said singularized particle; and
wherein said shape inspection station includes at least two cameras for sensing width, length and curvature characteristics of each of said singularized pellets and generating geometry signals containing geometric information representative of the geometric characteristics of each said singularized particle.

14. The vision inspection system as recited in claim 9, wherein said pellet feeder is operatively connected to a pellet feeder driver for controlling operating parameters of vibration frequency and vibrator amplitude of said pellet feeder, and wherein said conveyor belt is operatively connected to a conveyor driver for controlling moving speed of said conveyor belt.

15. The vision inspection system as recited in claim 10, further comprising:
a first computer for receiving said color signal and for processing said color information to provide first processed information;
a second computer for receiving said geometry signals and processing said geometric information to provide second processed information; and
a master computer for receiving and processing said first processed information and said second processed information and generating analyzed process system information relating to pellet characterizations and displaying resulting statistical information relating to pellet characterization.
